(19) United States
(12) Patent Application Publication
(10) Pub. No.: US 2015/0312170 A1
(43) Pub. Date: Oct. 29, 2015

(54) METHOD FOR ACTIVATING A SERVICE ON A PRINCIPAL DEVICE, AND RESPECTIVE APPARATUS

(71) Applicant: THOMSON LICENSING, Issy-les-Maoulineaux (FR)

(72) Inventor: Tim WITHOFS, Brasschaat (BE)

(21) Appl. No.: 14/654,497

(22) PCT Filed: Dec. 18, 2013
(86) PCT No.: PCT/EP2013/077203

§ 371 Date: Jun. 19, 2015

(30) Foreign Application Priority Data
Dec. 20, 2012 (EP) 12306641.7

(51) Int. Cl. H04L 12/947; H04L 12/931

(52) U.S. Cl. CPC H04L 49/25; H04L 49/352

(57) ABSTRACT

The method for activating a service on a principal device being connected, via a port connector comprising a set of pins, to a device suitable to provide an Ethernet service to the principal device, the set of pins having a first subset and a second subset of pins, wherein the first and the second subset of pins have no pins in common. The method comprises the steps of sensing always in an initial state for a Fast Ethernet service at the first subset pins and for a second service at the second subset of pins; detecting which of the Fast Ethernet service and the second service is signaled on the first and the second subset of pins; in case the second service is detected, then selecting the second subset of pins and activating the second service on the principal device; and in case the Fast Ethernet service is detected, then disabling the second service, selecting the first subset and second subset of pins and activating the Fast Ethernet service; and further, if a Gigabit Ethernet service is possible, enabling the Gigabit Ethernet service instead of the fast Ethernet service.

### TECHNICAL FIELD

The invention relates to the field of network ports management. More specifically, it relates to a method for using a single network port as a multipurpose network port.

### BACKGROUND

The amount of services that have to be offered by devices, such as residential gateways, typically expands. This results in a rise in the amount of ports on such systems. However, in a lot of cases, some services are mutual exclusive in the eyes of the customers using the device. For example, given a device with two separate ports, it often occurs that the customer uses the first port or the second port, but not both at the same time. However, in order to accommodate all possible needs, a system developer has to design a system taking into account all requested services even though they are mutual exclusive.

In addition to that, ports start to become a determining factor for design size even though they provide access to a single service. The amount of wasted space increases in the case of mutual exclusive services, as each service needs a separate port which can be quite large.

US2002106994 discloses a mobile phone handset having incorporated a multi-purpose connector and circuitries to connect to plain ordinary telephone lines, various computing devices and/or a local area network.

### SUMMARY OF THE INVENTION

The invention discloses a method for activating a service on a principal device being connected, via a port connector comprising a set of pins, to a device suitable to provide an Ethernet service to the principal device, the set of pins having a first subset and a second subset of pins, wherein the first and the second subset of pins have no pins in common. The method comprises the steps of:
sensing always in an initial state for a Fast Ethernet service at the first subset pins and for a second service at the second subset of pins;
detecting which of the Fast Ethernet service and the second service is signaled on the first and the second subset of pins;
in case the second service is detected, then selecting the second subset of pins and activating the second service on the principal device; and
in case the Fast Ethernet service is detected, then disabling the second service, selecting the first subset and second subset of pins and activating the Fast Ethernet service; and further, if a Gigabit Ethernet service is possible, enabling the Gigabit Ethernet service, instead of the fast Ethernet service, on the port connector comprising the first and second subset. Detection of the Fast Ethernet service starts in particular by enabling the fast Ethernet service followed by enabling the Gigabit Ethernet if Gigabit Ethernet capabilities are advertised during the Fast Ethernet detection.

In a preferred embodiment, the second service is an xDSL and/or a PSTN service and the port connector is an 8P8C modular connector or a RJ45 connector as used for Ethernet, xDSL and/or PSTN services.

In an aspect of the invention, the principal device comprises a selector component, which always switches the second subset of pins to the second service after switching on the principal device, and which switches to both first and second subset of pins when the Fast Ethernet service is detected for enabling the Gigabit Ethernet service, if Gigabit Ethernet capabilities are possible. The second service is therefore initially in a listing/detection mode after switching on the principal device.

In a further aspect of the invention, the method switches always to the initial state in which the second subset of pins for the second service is selected, if synchronization of a selected service is lost. At this stage the second service is in listening/detection mode. In case both the Fast Ethernet service and the second service are detected on both subsets of pins, then an error condition is reported to a user of the principle device and both the Fast Ethernet service and the second service are disabled.

An apparatus according to the invention comprises a port connector for connecting a device suitable to provide services to the apparatus, the port connector comprising a set of pins, the set of pins having a first and a second subset of pins, wherein the first and the second subset of pins having no pins in common. The apparatus comprises further detectors for detecting which of a first and a second service is signaled on the first and the second subset of pins and for activating the detected first or second service on the apparatus, and a selector component for selecting a third service on the apparatus, in case neither the first or second service is detected, wherein the third service requires a third set of pins of the port connector comprising the first and second subset of pins.

In a preferred embodiment, the first service is a Fast Ethernet service, and the third service is a Gigabit Ethernet service, wherein it is detected whether Fast Ethernet or the second service is enabled, and in the case neither Fast Ethernet nor the second service is detected, then the Gigabit Ethernet service is selected. The port connector is for example an 8P8C modular connector or a RJ45 connector. The second service is in particular an xDSL and/or a PSTN service.

In an aspect of the invention, the selector component always switches the second subset of pins to the second service after switching on the apparatus, and which switches to the Gigabit Ethernet service when neither Fast Ethernet nor the second service is detected.

In a further aspect of the invention, the selector component switches always to an initial state in which the second subset of pins for the second service is selected, if synchronization of a selected service is lost. This is in order to enable detection of the second service again after the link is lost.

The apparatus, respectively the principal device, is in particular a residential gateway.

For a better understanding, the invention shall now be explained in more detail in the following description with reference to the figures. It is understood that the invention is not limited to the described embodiments and that specified features can also expediently be combined and/or modified without departing from the scope of the present invention as defined in the appended claims.

### BRIEF DESCRIPTION OF THE DRAWINGS

FIG. 1 represents a flow diagram of the present invention, and

FIG. 2 shows the hardware configuration of a residential gateway illustrating an exemplary embodiment.

### DETAILED DESCRIPTION OF PREFERRED EMBODIMENTS

In the following, a preferred embodiment of a principal device of the invention will be described.

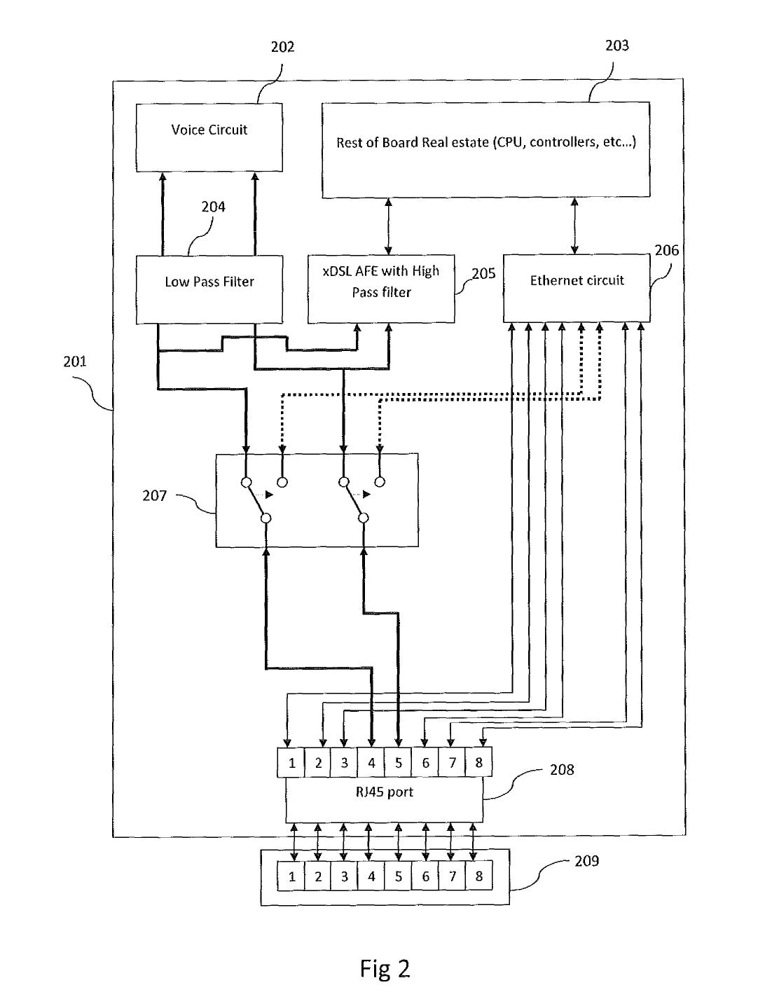

The principal device is in this example a residential gateway 201, as illustrated in FIG. 2. The residential gateway 201 comprises hardware features, namely:
An RJ45 port connector 208, also known as Ethernet or 8P8C connector
A 10BaseT/100Base-TX/1000Base-T Gigabit Ethernet interface with an Ethernet circuit 206
A selector component 207 controlled by the residential gateway to be able to automatically choose between the various available interfaces
A voice circuit 202, e.g. for a PSTN service
A low pass filter 204
An xDSL AFE (analog front end) with High pass filter 205
The rest of Board Real estate 203 of the gateway 201, comprising a CPU and controllers.

A RJ45 connector 209 is connected to the RJ45 port connector 208.

The pins of the RJ45 port connector 208 that can be used as multi-purpose pins are pins 4,5,7 and 8. The amount of multi-purpose pins used depends on the interfaces that are multiplexed. In the present exemplary embodiment, pins 4 and 5 are used, that is two multi-purpose pins. Depending on the nature of the access technologies that can be connected to the RJ45 port connector 208, one, two, three or four multi-purpose pins may be used.

A service provider offers multiple types of services to his end customers. In the example, those services are WAN (Wide Area Network) technologies, such as:
Ethernet
xDSL (ADSL, ADSL2, ADSL2+, VDSL, VDSL2 among others) and/or+ PSTN, wherein PSTN stands for Public Switched Telephone Network, and DSL stands for Digital Subscriber Line.

These services are provided to the residential gateway 201 via the RJ45 connector 209. The RJ45 connector 209 and the RJ45 port connector 208 have each eight pins.

The residential gateway has a selector component 207. This selector component 207 enables to select services to be activated on the residential gateway 201 among the following services: Fast Ethernet, Gigabit Ethernet, PSTN only, PSTN+xDSL or xDSL only.

The Fast Ethernet service is detectable on pins 1,2,3 and 6 of the RJ45 port connector 208. Once Fast Ethernet is detected, the system will also know if the port can be used for Gigabit Ethernet as well. If Gigabit functionality is possible then the Fast Ethernet service will be switched to a Gigabit service that is activated on the eight pins of the RJ45 port connector 208.

The modus operandi of the selector component 207 will now be described.

The selector component 207 has two selection modes: the first selection mode is “xDSL (+PSTN) mode” and the second selection mode is “Gigabit mode”.

In the selection mode “xDSL (+PSTN) mode”, pins 4 and 5 of the RJ45 port connector 208 are linked with the voice circuit 202 and the xDSL AFE 205 of the residential gateway 201, and pins 1, 2, 3, 6, 7 and 8 of the RJ45 port connector 208 are linked to the Ethernet circuit 206 of the residential gateway 201.

In the selection mode “Gigabit mode”, the eight pins 1-8 of the RJ45 port connector 208 are connected to the Ethernet circuit 206 of the residential gateway 201.

Whether the selector component is in “xDSL (+PSTN) mode” or is in “Gigabit mode”, the pins 1, 2, 3 and 6, 7 and 8 of the RJ45 port connector 208 stay connected to the Ethernet circuit 206 of the residential gateway 201. Consequently, in the two selection modes, the Ethernet circuit 206 of the residential gateway 201 enables to detect the signaling of an Ethernet service, via the pins 1, 2, 3 and 6 of the RJ45 port connector 208. A resulting advantage is the use of one port instead of two ports.

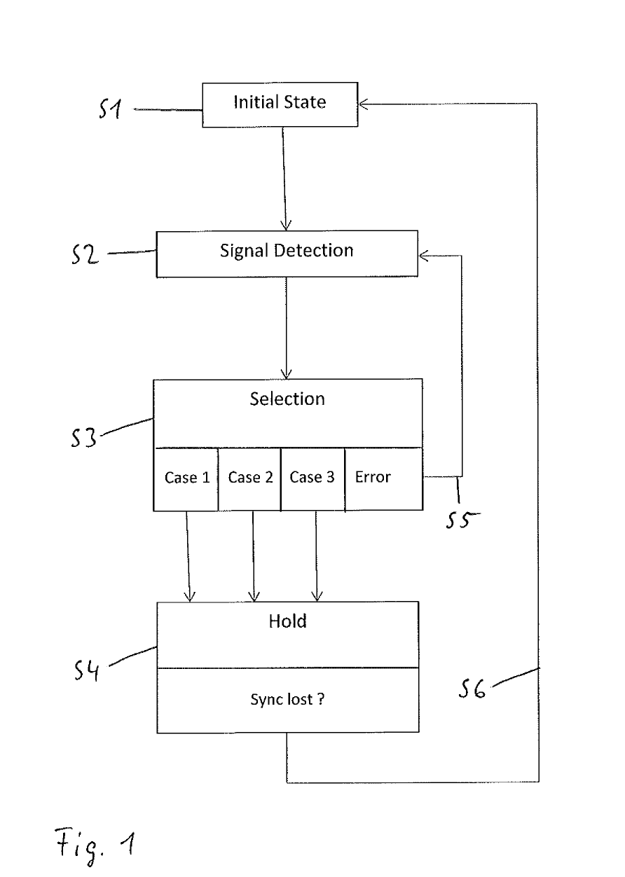

In an initial state S1, FIG. 1, the selector component 207 is set on “XDSL (+PSTN) mode”. In the “xDSL (+PSTN) mode” setting, the voice circuit 202 of the residential gateway 201 enables to detect the signaling of a PSTN service conveyed via pins 4 and 5 of the RJ45 port connector 208. The initial state is started for example when the residential gateway 201 is switched on, or after the residential gateway 201 has lost synchronization in one of its selection states.

The transmit part of the xDSL AFE (Analog Front End) 205 of the residential gateway 201 is disabled in the initial state and the receive part of the xDSL AFE 205 is enabled. This prevents signals from being driven onto the RJ45 port connector 208, while it is still allowed for the receive part of the xDSL AFE to detect if there is an xDSL service available.

Further, the Ethernet circuit 206 is enabled in the initial state S1 and uses the pins 1, 2 and 3, 6 to detect Fast Ethernet, e.g. 10/100 Mbit Ethernet signals.

Then, in a detection state S2, the voice circuit 202, the receive part of the xDSL AFE 205 and the Ethernet circuit 206 of the residential gateway sense continuously, and in parallel, respectively on pins 4 and 5 on the one hand and on the pins 1, 2, 3 and 6 on the other hand, the presence of any signaled service coming from a device connected to the residential gateway 201 via the RJ45 port connector 208 is detected. This sensing can be done in parallel because it is done on distinct sets of pins—namely 4 and 5 on the one hand for xDSL and PSTN, and 1, 2, 3 and 6 on the other hand for Ethernet—having no pins in common. Because xDSL and PSTN services are shared services on the same pins 4, 5 these services can be detected in parallel.

After the detection state S2, a selection state S3 follows. When the Ethernet circuit 206 of the residential gateway 201 detects Fast Ethernet signals on pins 1, 2, 3 and 6, Case 1, the xDSL and PSTN hardware of the residential gateway 201 is disabled, and the Ethernet circuit 206 changes the configuration mode of the selector component 207 to “Gigabit mode”: “Gigabit mode” of the selector component 207 is then enabled, and the Ethernet link is initialized. Then, the user waits for the Ethernet link to set. Once this link is set, the user is advised that the final state is “Ethernet”. If the synchronization is lost, then the selector component 207 returns to its initial state S1 in which xDSL+PSTN sensing is enabled.

When the voice circuit of the residential gateway 201 detects PSTN signals during the selection state S3, Case 2, then the selector component 207 is kept on the “xDSL +PSTN mode” setting. Two options are then possible: there is xDSL on top of the PSTN signal or not. If xDSL signals are detected by the xDSL AFE 205, the xDSL AFE 205 will enable it's transmitter to synchronize itself with an xDSL transceiver of a DSL provider connected to the residential gateway 201 via the RJ45 connector. The user is advised via an indicator that xDSL is trying to synchronize and is asked to not disconnect the cable. The Ethernet interface with the Ethernet circuit 206 is then set to disabled. If xDSL signals are not detected, that is, when no handshake has been detected by the DSL AFE after X seconds, the user is advised via an indicator that the PSTN service is activated and that the xDSL service is not activated. However xDSL may keep on trying to synchronize.

When after X seconds after starting the initial state S1, no PSTN signals or Ethernet signals are detected, the xDSL AFE 205 of the residential gateway will look for xDSL signals, Case 3. The transmitter of the xDSL AFE 205 is enabled and tries to synchronize itself with the xDSL transceiver for Y seconds. The user is advised via an indicator not to unplug the cable.

If the xDSL AFE 205 can finalize xDSL synchronization, the user is advised via an indicator that xDSL is activated. The final selected interface is then set to “DSL only” and the Ethernet interface is set to disabled. In case synchronization is lost after some time, the residential gateway 201 returns to the initial state S1.

If no DSL signals are detected by the xDSL AFE 205 after Y seconds of xDSL synchronization, then the xDSL AFE 205 switches off. The user is advised that he can plug in an Ethernet device at this time. The residential gateway 201 waits for X seconds for any PSTN or Ethernet signal, before trying to initialize xDSL again.

If at any time, both Ethernet signaling and PSTN or xDSL signals are detected before an interface is finally selected, an error state “Error” is flagged toward the user with an indication to unplug the cable and check wiring. The residential gateway 201 halts the detection process then into an error state, when no signal is detected during Z seconds. After Z seconds of no signal, step S5, the residential gateway 201 starts again with the detection state S2.

After detection and selection of one of the cases 1-3, the residential gateway 201 remains in a hold state S4. In case synchronization is lost during the hold state S4 for anyone of the cases 1-3, the residential gateway 201 returns to the initial state S1, step S6.

The invention has the advantage that more than one service can be provided on the principal device via a single port, wherein for all possible situations it is avoided that a dangerously higher voltage is connected to the Ethernet circuit 206, for example a 48 V voltage as provided by the POTS service via pins 4 and 5. The amount of connectors of the principal device is reduced therefore, wherein the selection mechanism is automated, meaning limited constraints for the user. Also, unused interfaces are clearly defined after selection and are powered off to save power.

Also other embodiments of the invention may be utilized by one skilled in the art without departing from the scope of the present invention. The invention is in particular not limited to a residential gateway, or to the xDSL and/or the PSTN service as the second service. The invention resides therefore in the claims herein after appended.

1-15. (canceled)

16. Method for activating a service on a principal device connected, via a port connector comprising a set of pins, to a device suitable to provide an Ethernet service to the principal device, the set of pins having a first subset and a second subset of pins, the first and the second subset of pins having no pins in common, the method comprising:
sensing always for a Fast Ethernet service at the first subset of pins and for a second service at the second subset of pins in an initial state;
detecting which of the Fast Ethernet service and the second service is signaled on the first and the second subset of pins;
in case the second service is detected, then selecting the second subset of pins and activating the second service on the principal device;
in case the Fast Ethernet service is detected, then disabling the second service, selecting the first subset and second subset of pins and activating the Fast Ethernet service; and further, if a Gigabit Ethernet service is possible, enabling the Gigabit Ethernet service, instead of the fast Ethernet service, on the port connector comprising the first and second subset, and
switching always to the initial state, if synchronization of a selected service is lost, wherein in the initial state the second subset of pins for the second service is selected.

17. Method according to claim 16, wherein the port connector is an 8P8C modular connector or a RJ45 connector.

18. Method according to claim 16, wherein the second service is an xDSL and/or a PSTN service.

19. Method according to claim 16, comprising: in case both the Fast Ethernet service and the second service are detected on both subsets of pins, then reporting an error condition to a user and disabling both services.

20. Method according to claim 18, comprising: in case both the Fast Ethernet service and the second service are detected on both subsets of pins, then reporting an error condition to a user and disabling both services.

21. Method according to claim 18, wherein the principal device comprises a selector component, which always switches the second subset of pins to the second service after switching on the principal device, and which switches to both first and second subset of pins when the Fast Ethernet service is detected for enabling the Gigabit Ethernet service, if Gigabit Ethernet capabilities are possible.

22. Method according to claim 20, wherein the principal device comprises a selector component, which always switches the second subset of pins to the second service after switching on the principal device, and which switches to both first and second subset of pins when the Fast Ethernet service is detected for enabling the Gigabit Ethernet service, if Gigabit Ethernet capabilities are possible.

23. An apparatus with a port connector for connecting a device suitable to provide services to the apparatus,
the port connector comprising a set of pins, the set of pins having a first and a second subset of pins, the first and the second subset of pins having no pins in common,
the apparatus comprising detectors for detecting which of a first and a second service is signaled on the first and the second subset of pins and for activating the detected first or second service on the apparatus, and a selector component for selecting a third service on the apparatus, in case neither the first or second service is detected, the third service requiring a third set of pins of the port connector comprising the first and second subset of pins, wherein
the selector component always switches to an initial state in which the second subset of pins for the second service is selected, if synchronization of a selected service is lost.

24. The apparatus of claim 23, wherein the port connector is an 8P8C modular connector or a RJ45 connector.

25. The apparatus of claim 23, wherein the first service is a Fast Ethernet service, and the third service is a Gigabit Ethernet service.

26. The apparatus of claim 23, wherein it is detected whether Fast Ethernet or the second service is enabled, and in the case neither Fast Ethernet nor the second service is detected, then the Gigabit Ethernet service is selected.

27. The apparatus of claim 23, wherein the second service is an xDSL and/or a PSTN service.

28. The apparatus of claim 23, wherein the selector component always switches the second subset of pins to the second service after switching on the apparatus, and which switches to the Gigabit Ethernet service when neither Fast Ethernet nor the second service is detected.

29. The apparatus of claim 27, wherein the selector component always switches the second subset of pins to the second service after switching on the apparatus, and which switches to the Gigabit Ethernet service when neither Fast Ethernet nor the second service is detected.

30. The apparatus according to claim 23, wherein the apparatus is a residential gateway.
